(19) United States
(12) Patent Application Publication
(10) Pub. No.: US 2007/0203759 A1
(43) Pub. Date: Aug. 30, 2007

(54) Portfolio management system with gradient display features

(75) Inventors: Shajy Mathai, Chester, NJ (US); Maya E. Belubekian, Greenwich, CT (US); Elizabeth Soh, Leonia, NJ (US)

Correspondence Address: SEYFARTH SHAW LLP, 131 S. DEARBORN ST., SUITE2400, CHICAGO, IL, 60603-5803, US

(73) Assignee: Guy Carpenter & Company

(21) Appl. No.: 11/710,874

(22) Filed: Feb. 26, 2007

Related U.S. Application Data
(60) Provisional application No. 60/776,987, filed on Feb. 27, 2006.

(51) Int. Cl. G06Q 40/00

(52) U.S. Cl. 705/4

(57) ABSTRACT

The present invention provides a tool to depict the relative impact to the losses of a insurer's portfolio from catastrophic events, such as a hurricanes or earthquakes, at a specific risk level by geographic area using a grid level database and a spatial database to generate maps. The maps developed using this tool help visualize the potentially dangerous areas for writing new business and/or identify preferential places for growth. The tool also creates a list of zip codes with incremental losses at a particular risk level representing the relative attractiveness of writing new policies (or eliminating existing policies) in one zip code versus another. The spatial database provides rich spatial geometry features in the form of raster images available in the spatial database and the invention provides the corresponding spatial algebra to create relativity maps with gradient features and zip code loss information.

The present application claims its priority date from co-pending provisional patent application Ser. No. 60/776,987 filed Feb. 27, 2006.

### BACKGROUND

The present application pertains to a portfolio management system and method for managing data and portfolios and displaying loss data on maps using gradient features generated and stored by a grid-level database and a spatial database.

Currently, more and more insurance companies are taking a pro-active approach to portfolio management and, instead of just assessing potential losses of the current portfolio of insurance policies, they are trying to evaluate the geographic impact of writing new policies based on their portfolio's performance. Typically, there is a certain layer of risk that is the most critical for managing called a Risk Managed Layer (RML). The selection of a RML can be affected by a variety of factors and parameters, such as a reinsurance layer's attachment and limit, A.M. Best's rating requirements, etc.

A goal of insurance portfolio management is to determine where the best locations are for growth/attrition of business from the catastrophe loss perspective for a particular risk level. In other words, it is necessary to identify geographic areas that will contribute a significant amount to the existing portfolio's loss in the selected tail risk layer (say, above 1:100 year event, or between 1:50 and 1:150 year events) if new exposure was added in these areas. A challenge is to identify the geography of potential risks that contribute to a very specific layer of risk (tail loss) rather than to entire set of catastrophic events (expected loss). This is because expected losses are additive between two portfolios (current and incremental), whereas the tail losses are not additive.

Usually, portfolio management is done based on expected loss because of the relative easiness of this approach. It is worth noting, that if expected loss was estimated in the incremental uniform portfolio instead of tail loss, the contribution to loss would have the same spatial pattern for each insurer. It is desired to have a system to determine the tail loss contribution where the spatial pattern is always unique to a particular insurer, because the events that “drive” the losses in the risk layer are insurer-specific.

The present invention provides a system to analyze and predict an insurance insurer's losses in a RML that would be affected if an incremental exposure was added to the portfolio in various geographic locations. Such analysis allows for detection of relatively more or less attractive areas for business growth, as well as for attrition of policies.

Methods of establishing insurance rates at a desired location and generating three-dimensional contour charts are known, which depict services that reflect insurance rates based on expected losses for each grid point. Such known systems use inverse distance rating in order to plot points away from each central point of a grid based on expected loss information.

Other systems are known that provide for a method for catastrophe insurance risk assessment using a probability distribution for given geographic locations. Such systems use stochastic simulations that are carried out using histograms of typical probability distribution for natural disasters, probability distribution for loss of lives or property, and policy payouts to determine average policy losses.

Still other systems are known that determine concentrations of potential liability and exposure relating to catastrophic events regarding insurance portfolios and include operations for storing and linking policy information, portfolio information, account information, financial perspectives or other information that is identified using longitude and latitude coordinates or zip codes. Such systems describe a process to determine concentrations of exposure, including providing a grid that includes an area of analysis boundary. The boundary is moved around the region of interest in order to generate a new area of analysis each time the boundary is moved so that exposure amounts at each area of analysis can be determined. A total exposure for an area of analysis may be determined by totaling the net exposures for each exposure location located within the area of analysis and such exposures may be associated with specific perils, such as earthquakes, tornadoes, terrorist attacks, windstorms or other manmade or natural perils. The exposure data may be output in a graphical form, such as a map showing locations having the highest exposure concentration or using specific graphic indicia or colors to determine various concentration levels.

Other systems disclose insurance classification plan loss control systems that generate a plurality of predicted loss ratios for policy holders and determine a difference between the actual loss ratio of the policy holders. Such known systems include a relativity adjustment apparatus, including a bin generator that sorts data points by their predicted loss ratio and a fixed number of consecutive data points that constitute a bin. The bin generator calculates an average of all predicted loss ratios and a standard deviation of all predicted loss ratios. A derived actual loss ratio may be used to determine a premium pricing effectiveness.

However, such systems discussed above (a) do not consider tail loss in developing its mapping data, (b) fail to disclose the use of gradient features that are representative of catastrophe losses to graphically illustrate risk surfaces on the map, (c) fail to disclose the step of modeling incremental tail loss in a RML, (d) fail to disclose the step of selecting events in a RML from an exceedance probability curve, and (e) fail to express spatial data in raster format and perform raster algebra on the spatial data to calculate contribution to loss in the RML and generate maps including gradient features.

### THEORETICAL BACKGROUND

The problem of portfolio management can be stated as follows: What is the impact of adding exposure to the current portfolio in various geographic areas based on the change in losses in a selected RML? More formally put, given the current portfolio exposure is P₀ and the selected RML is composed of a set of events {RML(P₀)}, what is the change in loss to the RML when some exposure ΔP is added to the current portfolio?

Let us denote the portfolio losses by L. Then, we need to find:

E[ΔL_{RML}]=E[L(P₀+ΔP)|{RML(P₀+ΔP)}]−E[L(P₀)|{RML(P₀)}]. (1)

If the RML event set, {RML}, did not change when considering portfolios P and (P+ΔP), in other words, the probabilistic event space of the RML did not change and

{RML(P₀)}={RML(P₀+ΔP)}, then the right hand side of (1) could be exactly calculated as:

E[L(P₀+ΔP)|{RML(P₀+ΔP)}]−E[L(P₀)|{RML(P₀)}]=E[L(ΔP)|{RML(P₀)}]. (2)

In reality, when portfolio exposure changes, the composition of events in the RML changes as well ({RML(P₀)}< >{RML(P₀+ΔP)}), and the equality (2) does not hold. But, if the change to the portfolio is only incremental (small compared to the initial portfolio size), then the majority of the events forming the RML for the initial and incremented portfolio will be the same:

$$\frac{\# [ \{ RML ( {P}_{0} ) \} ⋂ \{ RML ( {P}_{0} + Δ P ) \} ]}{\# [ \{ RML ( {P}_{0} ) \} ⋃ \{ RML ( {P}_{0} + Δ P ) \} ]} is close to one ( \# denotes number of events ) .$$

In such a case, (2) holds approximately:

E[L(P₀+ΔP)|{RML(P₀+ΔP)}]−E[L(P₀)|{RML(P₀)}]˜E[L(ΔP)|{RML(P₀)}].

In summary, for all practical purposes, it is reasonable to approximate the change to the losses in the RML from addition of incremental exposure by the losses of the incremental portfolio:

E[ΔL_{RML}]˜E[L(ΔP)|{RML(P₀)}]. (3)

Based on this conclusion, it is not necessary to model a insurer's portfolio with added exposures in order to find the impact of such exposure change on the losses to the RML. It is sufficient to model only the incremental exposure itself and calculate the E[L(ΔP)|{RML(P₀)}].

The incremental exposure has to be uniformly distributed geographically so that all areas of interest are assessed in terms of their relative impact on the losses to the RML. Creating equally spaced grids with equal units of exposure (same Total Insured Value, same construction) and calculating corresponding losses to the RML achieves this purpose. The exposure grids for every state are generic, insurer-independent and can be analyzed only once in a certain model version (a time and computer resource consuming procedure). Once the results are obtained for the grid losses at location level detail, they can be used for each insurer's analysis to calculate E[L(ΔP)|{RML(P₀)}] with the insurer-specific RML.

The insurers must be aware that the results of this sensitivity analysis are only valid if the portfolio changes according to the recommended geographic strategies by a small percentage only. Drastic changes to the portfolio exposures can completely change the composition of the RML, and, therefore, may not be a good approximation anymore. The new portfolio would need to be re-analyzed with adjusted RML events.

### SUMMARY OF THE INVENTION

In an embodiment, the invention provides a tool that includes a grid level database and a spatial database that develops maps identifying preferential places for insurance growth and loss prevention and also creates a zip code index comparing the attractiveness of writing business in one zip code versus another. The system creates an incremental portfolio that consists of the same-value and same-construction exposures located in the nodes, or pixilated points, of an equally-spaced grid. This portfolio is modeled in a catastrophe model to obtain losses to each location in the grid from each stochastic catastrophe event. For specific events from a insurer's portfolio that fall into the RML, the spatial impact of a the incremental portfolio to the insurer's RML losses can be evaluated using the pre-modeled event losses of the incremental portfolio. By determining tail loss contribution, the spatial pattern will be unique to each particular insurer based on the individual insurer's portfolio, which drives the losses in the RML. Approximation of the changes to losses in the RML occurs because adding incremental exposure may change the composition of events in the RML. But such change is insignificant if the incremental exposure is small compared to the insurer's original portfolio.

In an embodiment, the present invention provides a data analysis system comprising a grid level exposure database for storing exposure data including a uniform grid of equal exposures, a grid level loss database for storing pre-modeled insurance portfolio loss data for the uniform grid of equal exposures to catastrophe events and a geo-spatial database for receiving the loss data and user input in order to generate maps that include gradient features depicting contribution to loss in an RML. The system may include the geo-spatial database that includes catastrophic loss data and the maps being generated to provide gradient features that reflect the catastrophic loss data with respect to insured property valves.

The system may include the loss data in raster format where raster algebra is performed on the loss data to calculate contribution to loss in the RML. The system may include a geo-spatial database that plots pixilated points correlated to the insurance portfolio data. The system may further comprise a geo-spatial application for scripting the insurance portfolio data. The system may provide the gradient features that comprise various graphical indicia depicted on a map with each indicia representative of different data points.

In an embodiment, the invention comprises a data analysis system that includes a processor to that calculates a spatial distribution of events that contribute to tail loss with respect to insurance portfolio. The spatial data is then stored in raster format, and raster algebra is performed on the spatial data to calculate contribution to loss in an RML. Results are then sent to an end user device with maps that include gradient features. The insurance portfolio may include catastrophic loss data and the map may be generated to provide gradient features representative of the catastrophic loss data. The processor may include a spatial database having a geo-spatial software in order to plot pixilated points correlated to the insurance portfolio data. The processor may include a geo-spatial application for scripting the insurance portfolio data. The gradient features may comprise various graphic indicia, such as cross-hatching or colors depicted on a map and each indicia or color is representative of different data points. The data points may include catastrophic loss data for hurricane, tornado, flood, earthquake, windstorm or manmade peril data.

In a further embodiment, a method of conducting data analysis is provided that comprises the steps of modeling incremental tail loss at pixilated points and developing a grid of pixilated points with buildings exposed to catastrophe events across a wide geographic area. The method may further comprise the step of selecting events in the RML from an exceedance probability curve modeled from insurance portfolio data. The method may further comprise the step of developing a map to identify preferential places for insurance growth. The method may further comprise the step of developing a map to identify preferential places for loss prevention. The method may further comprise the step of developing a map with a zip code index that compares the attractiveness of writing business in one zip code versus another zip code. The method may include the same-value and same-construction exposures located in the nodes or pixilated points of an equally-spaced grid. The method may further comprise the step of modeling grid level tail losses for an existing insurance portfolio in order to evaluate the sensitivity of each geographic area to the increase in losses in the RML.

The method may further comprise the step of calculating the tail loss for each location in the grid. The method may further comprise the step of determining tail loss contribution in order to provide a spatial pattern that will be unique to each particular insurer based on the individual insurer's portfolio, which drives the losses in the RML. The method may further comprise the step of approximating the changes to losses in the RML that occur by addition of incremental exposure by the losses of the incremental portfolio.

The method may further comprise the step of modeling incremental exposure by uniformly distributing pixilated points geographically, so that all areas of interest are accessed in terms of their relative impact on the losses to the RML. The method may further comprise the step of creating equally spaced grids with equal units of exposure and calculating corresponding losses to the RML. The method may further comprise the step of obtaining results for the grid losses at each location level detail and using the grid losses for each insurer's analysis to calculate a specific RML. The method may further comprise the step of overlaying maps having expected loss and concentration of policy data and generating an overall map depicting gradient features that are representative of catastrophe losses by using different indicia or colors. The method may operate where the tail loss is equal to the RML. The method wherein gradient features may depict rate adequacy ratings. The method may further comprise the step of representing risk management data using the maps and analyzing the risk management data via the maps. The method may further comprise selecting events from an exceedance probability (EP) curve where the RML is unbounded with respect to the return period and where each loss on the EP curve is paired with a simulation event.

In another embodiment the invention provides for a system for displaying geographic and insurance portfolio data comprising an end user device including a computer readable signal-bearing medium, the medium having a circuit for receiving insurance portfolio data and data parameters input by a user of the end user device, the data parameters for calculating a spatial distribution of events that contribute to tail loss with respect to the insurance portfolio data and map data received by the end user device, the map data depicting the spatial distribution using gradient features. The end user device may be a computer connected to a network and transmitting and receiving insurance portfolio data via the internet and displaying the map data including pixilated points representative of specific events for an RML providing an estimate of incremental tail loss for each pixilated point. The end user device may be connected to the internet and is capable of receiving email and the email including data representative of events for an RML for providing an estimate of incremental tail loss with respect to particular geographic region having pixilated points representative or the map data.

### BRIEF DESCRIPTION OF THE DRAWINGS

For the purpose of facilitating an understanding of the subject matter sought to be protected, there are illustrated in the accompanying drawings embodiments thereof, from an inspection of which, when considered in connection with the following description, the subject matter sought to be protected, its construction and operation, and many of its advantages should be readily understood and appreciated.

FIG. 1 is a flow chart depicting the application architecture for an embodiment of the present invention;

FIG. 2 is a flow chart describing a method of performing an embodiment of the present invention;

FIG. 3 is a screen-shot of a user interface input screen;

FIG. 4 is a chart depicting an exceedance probability curve of an embodiment of the present invention.

FIG. 5 is a screen-shot of a map generated for an embodiment of the present invention depicting a map of conditional RML loss for a state at Grid-level;

FIG. 6 is a screen-shot of a map generated for an embodiment of the present invention depicting a map of conditional RML loss for a state at Zip-code level; and

FIG. 7 is a table depicting an excerpt of a Zip-Code list with RML losses for an embodiment of the present invention.

### DETAILED DESCRIPTION

The present invention provides maps and zip code lists of RML losses that are available for catastrophic events, such as for earthquakes and hurricanes. Technology/tools used may include a processor having a computer readable signal-bearing medium, such medium having circuits, such as hardware including a spatial database (e.g., an Oracle Spatial Database), and geo-spatial software, such as PCI Geomatica, and a geo-spatial application, such as EASI script. The system includes an end user device, such as a computer, personal digital assistant (PDA), cell phone or other electronic device, which can send and receive signals via the internet, including emails and other data files that include RML losses depicted with gradient features.

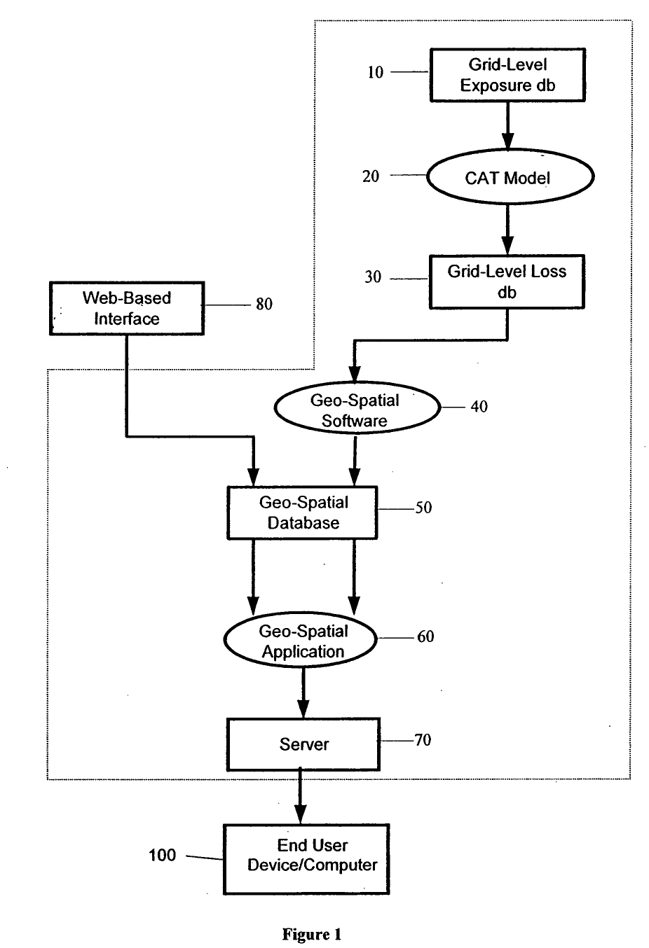

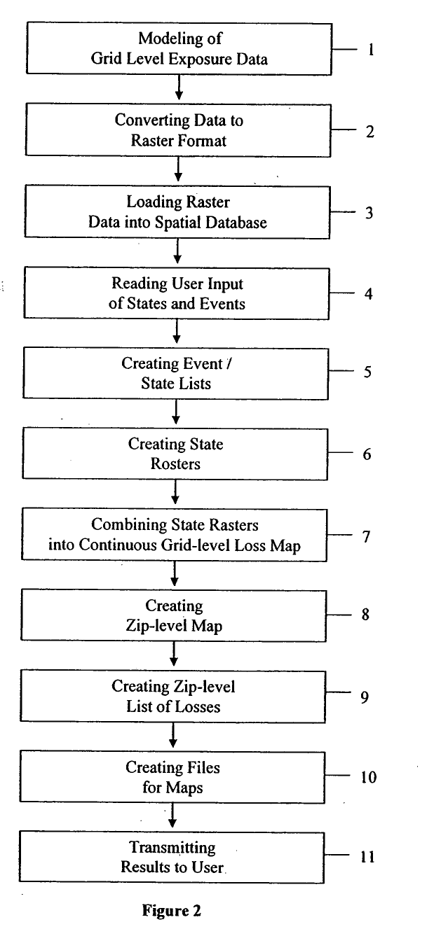

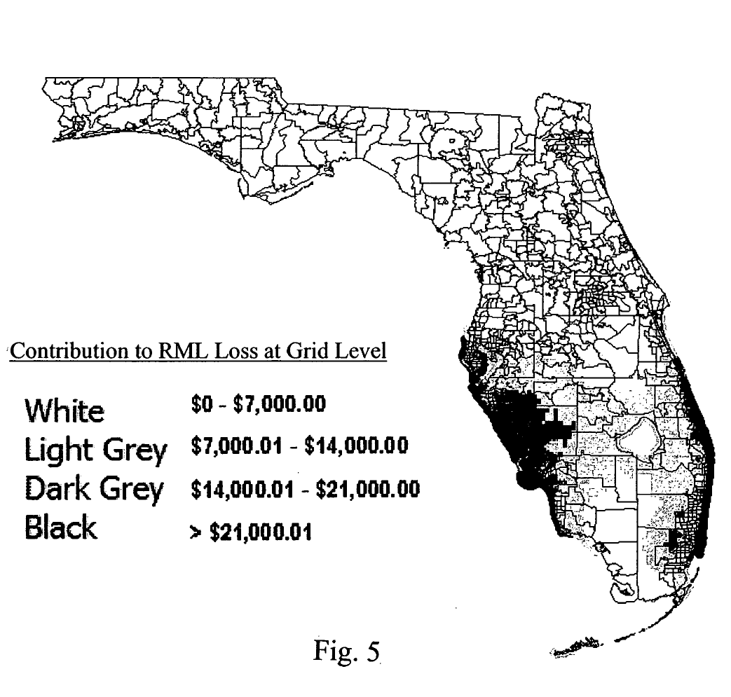

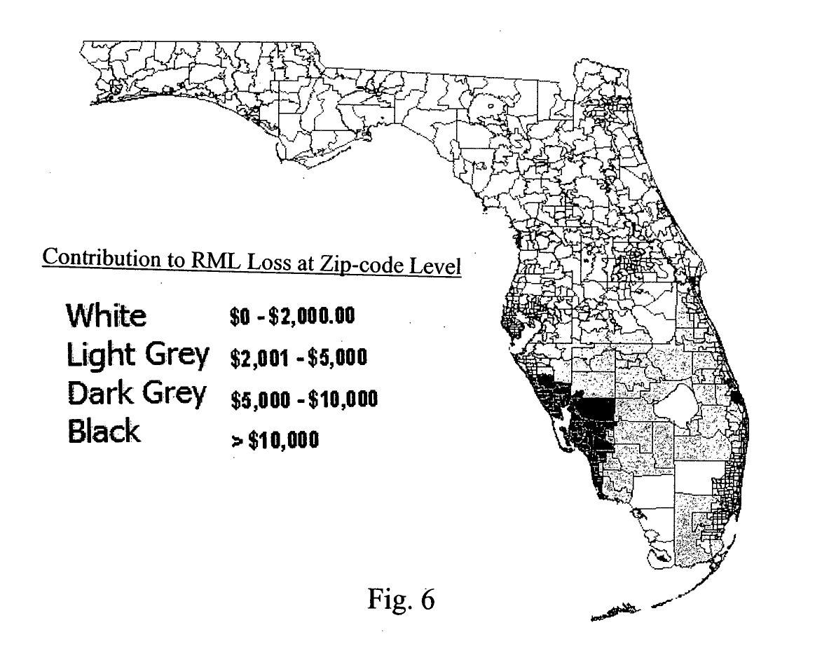

The major steps of an embodiment of the present invention are depicted in FIG. 1 and FIG. 2. Step 1 involves modeling of grid-level exposure data from the grid-level exposure database 10 and to obtain grid-level loss by event from the grid-level loss database 30 for all hurricane and earthquake-prone states via a catastrophic (CAT) model 20. In an embodiment, events may be selected using a SQL query. Other data such as insurance premiums or other catastrophic events may also be used with the present invention to provide sensitivity data with respect to underwriting guidelines. For example, the maps of FIGS. 5 and 6 depict gradient features identified by colors of white, light gray, dark gray and black as described below.

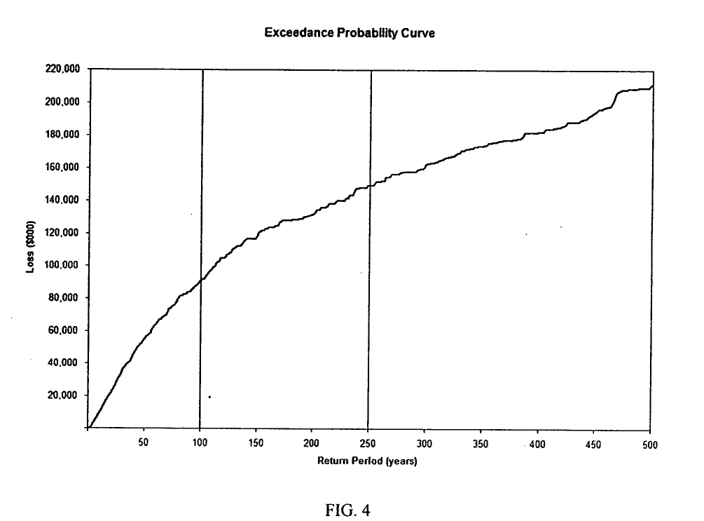

The present invention can provide a general growth/attrition analysis that uses a insurer's exceedance probability (EP) curve and location level grid loss results for the state(s) of interest in the selected model version (for example, see FIG. 4). In an embodiment, the following steps are followed to model the grid-level exposure.

Build an EP curve from event set data where corporate level EP is desirable and net pre-catastrophic perspective is common, as shown in FIG. 4. Identify the RML, which may depend on a insurer's risk tolerance and business goals and may coincide with reinsurance program attachment and limit or with one (or a few) of the program's layers. As an example, FIG. 4 has tail losses, or high return periods (EP points), between 100 and 250 years highlighted in order to determine the contribution to loss in the RML. Building an EP curve from an event set data such that every loss is associated with a simulation event, and then selecting RML boundaries on the same EP curve to identify the portion of the EP that will be considered in the analysis.

Make a list of events that form the RML and check which states are mostly affected by the selected RML events. Based on that correlation and the insurer's exposure data, decide which states to include in the analysis. Input the relevant states and the selected RML events to the application.

The system (application) will calculate the conditional expected loss for the RML events at each grid point and will also “roll-up” these losses at zip-code level by averaging them. These losses (both at grid and zip-code level) represent contributions to the insurer's RML losses. The system will make thematically shaded maps of grid and zip-code level loss contributions to the insurer's RML. The system will also output a list of these loss values by zip-code.

The methodology used is based on pre-modeled losses for uniform grids of equal exposures stored in the grid-level exposure database 10 as a $100,000 wood building in each grid point. The grid-level loss database 30 is a result of running a catastrophe (CAT) model 20 and consists of location information and the losses to each location from all the stochastically generated earthquake, hurricane or other events. The pre-modeled data is used in combination with insurer-specific loss data 30 to find incremental losses to the insurer's portfolio RML from adding the described uniform portfolio. The resulting spatial distribution of incremental RML losses 40, 50, 60 can be used as a roadmap for designing underwriting guidelines, together with other parameters, such as premium rates, agent information, other losses, etc.

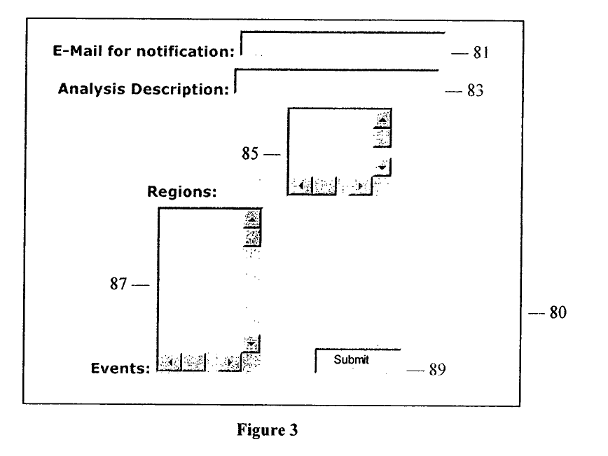

Returning to FIGS. 1 and 2, at step 2, a geo-spatial software 40 is used to convert loss data into raster format for a geo-spatial database 50 (one raster per event). At step 3, raster loss data is loaded into a spatial database 50. Step 4 includes reading user input of states and events from a web-based interface 80 (such as shown in FIG. 3) for analysis and the user's e-mail address. For example, the user interface 80 may include spaces 81 for entering the end user's email address, space 83 for inserting an Analysis Description or Title for the analysis; space 85 for identifying the regions or states that should be included in the analysis (in an embodiment, a drop-down menu listing regions or 50 states may be provided for user selection); and space 87 is for inserting specific events to be analyzed. In an embodiment, multiple drop-down menus may be provided, for instance listing recent catastrophic events, such as hurricanes, etc. Finally, the user input parameters may be transmitted to the geo-spatial database 50 by clicking on the “Submit” button 89. The user interface 80 may be accessed by an end user device, such as a computer or PDA, via the internet. In an embodiment, the web-based interface 80 may reside on a third-party host server, within the same system as server 70 or on the end user device computer 100.

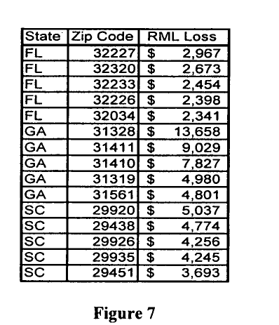

Step 5 allows the geo-spatial database 50 to create event/state lists based on user input provided at the interface 80 in order to select relevant events from the grid-level loss database 30. At step 6, state rasters are created for considered events. Step 7 combines state rasters into a continuous grid-level loss map. Rasters representative of other geographic areas may also be used. At step 8, zip-level maps are created by aggregation and averaging of grid-level loss map (see FIG. 6). At step 9, corresponding zip-level list of losses are created using a geo-spatial software application 60 (see FIG. 7). For example, FIG. 7 depicts an alternate embodiment of the invention wherein a region that includes Florida, Georgia and South Carolina Zip-code level data is used by the geo-spatial application. Step 10 creates shape files for the grid- and zip-level maps and geo-referenced *.tif files for the grid- and zip-level maps, and legends for the grid- and zip-level maps; and has a server 70. Finally, at step 11, the server 70 transmits the results to the user's end user device 100 such as a computer, PDA (e.g., via e-mail) or printer. The data sent to the user can be in the form of maps such as in FIGS. 5 and 6 and a list of zip code level loss contributions to insurer's RML that may be displayed or generated by the device 100. It is to be understood that the present invention maybe accomplished even if one or more of the above steps were varied.

In view of the above description it can be observed that the present invention provides maps that identify preferential places for insurance growth and loss prevention and also creates a zip code index that compares the attractiveness of writing business in one zip code versus another as shown in FIG. 6. The system creates an incremental portfolio that consists of the same-value and same-construction exposures located in the nodes, or pixilated points, of an equally-spaced grid and models this portfolio via a catastrophe model to obtain losses at each point of the grid for each of the stochastic catastrophe events. For specific events from a insurer's portfolio that fall into the RML, the conditional expected loss is calculated for each location in the grid. This conditional expected loss represents the RML contribution to the insurer's portfolio. By determining tail loss contribution, the spatial pattern will be unique to each particular insurer based on the individual insurer's portfolio, which drives the losses in the RML. Approximation of the changes to losses in the RML occurs because adding incremental exposure may change the composition of events in the RML. But such change is insignificant if the incremental exposure is small compared to the insurer's original portfolio.

The system models incremental exposure by uniformly distributing these pixilated points geographically, so that all areas of interest are accessed in terms of their relative impact on the losses to the RML. The system creates equally spaced grids (in the grid-level exposure database 10) with equal units of exposure and calculates corresponding losses to the RML (in the grid-level loss database 30). Such grids can be used with maps of particular regions, for example as shown in FIG. 5, depicting Florida where contribution to the RML loss is determined by adding a $100,000 wood frame building in each grid point (e.g. each latitude and longitude segment). In other embodiments, contribution to loss in the RML can use other uniform changes (e.g., brick building, $200,000 added, etc.). The map shows gradient ranges by graphic indicia, such as color (limited presently to white, gray and black only so that printing of this patent application in black and white allows for each range to be visible). For example, white designates RML loss ranges of 0-$2,000; light gray designates RML loss of $2,001-$5,000; dark gray designates $5,001-$10,000; and black gradient zones on the map designate RML loss of greater than $10,000. It is to be understood that other regions can be selected (e.g., by county, state, region or by country, etc.) for grid-level or Zip-code level map (FIG. 6). It is also to be understood that more level or gradations of data can be shown on the maps using additional indicia, such as colors or cross-hatching. Once the results are obtained for the grid losses at each location level detail, they can be used for each insurer's analysis to calculate a specific RML. For example, by overlaying maps having expected loss, concentration of policies and other constraints; an overall map is generated depicting gradient features that are representative of catastrophe losses by using different indicia or colors (e.g., rate adequacy ratings). Risk management data and sensitivity data are easily represented and analyzed via the gradient features provided by such maps.

The present invention may be developed as a web-based tool and the user needs to input via a web-based interface 80 the state(s) of interest and the events that are driving the RML losses in the insurer's current portfolio. The resulting maps and zip code-level RML loss information are transmitted to the user's end user device, such as a computer or PDA, after the analysis is completed.

The present invention provides a portfolio that consists of the same-value and same-construction exposures located in the nodes of a fine equally-spaced grid. This small incremental portfolio can be virtually overlaid on top of the existing insurance portfolio to uncover the sensitivity of each geographic area and to the increase in losses in the risk layer.

In an embodiment, insurer portfolio events are identified that fall into the selected risk layer. Then, for these events, the loss is calculated for each location in the incremental uniform portfolio. This loss represents the spatially distributed contribution to loss in the risk layer. Here, an implicit assumption is made that by adding this small portfolio, the events in the risk layer stay the same and so the tail losses become additive. This is a reasonable assumption as if a sufficiently wide layer is selected (more than 10 events), the majority of the events in the layer are the same between the original and increased portfolios. Calculating risk layer loss in each location of uniform portfolio is a technologically challenging task and requires a lot of computer memory. In order to accomplish such calculations, a database 10, such as an Oracle Spatial Database, may be used.

While particular embodiments have been shown and described, it will be apparent to those skilled in the art that changes and modifications may be made without departing from the principles of the invention in its broader aspects. Details set forth in the foregoing description and acinsurering drawings are offered by way of illustration only and not as a limitation. The actual scope of the present invention is intended to be defined in the claims below when viewed in their proper perspective based on the prior art.

What is claimed is:

1. A data analysis system comprising:
a grid level exposure database for storing exposure data including a uniform grid of equal exposures;
a grid level loss database for storing pre-modeled insurance portfolio loss data for the uniform grid of equal exposures to catastrophic events; and
a geo-spatial database for receiving the loss data in raster format and user input in order to generate maps that include gradient features depicting contribution to loss in a risk managed layer (RML).

2. The system of claim 1 wherein the geo-spatial database includes catastrophic loss data that contribute to tail loss with respect to the insurance portfolio data and the maps being generated to provide gradient features that reflect the catastrophic loss data with respect to insured property values.

3. The system of claim 1 wherein the loss data in raster format is spatial data and raster algebra is performed on the spatial data to calculate contribution to loss in the RML.

4. The system of claim 1 wherein the geo-spatial database provides the uniform grids by plotting pixilated points correlated to the insurance portfolio data and providing equal exposures by adding the cost of a wood frame building in each grid point from the grid level exposure database.

5. The system of claim 1 further comprising a geo-spatial application for scripting the insurance portfolio data and generating maps from raster data.

6. The system of claim 1 wherein the gradient features comprise various graphical indicia depicted on a map and each indicia representative of different data points.

7. A data analysis system comprising:
a processor that calculates spatial data pertaining to events that contribute to tail loss with respect to the insurance portfolio data and the spatial data in raster format where raster algebra is performed on the spatial data to calculate contribution to loss in a risk managed layer (RML); and
an end user device to display maps that include gradient features identifying the contribution to loss in RML.

8. The system of claim 7 wherein the insurance portfolio includes catastrophic loss data and the maps being generated provide gradient features that reflect the catastrophic loss data.

9. The system of claim 7 wherein the processor includes a spatial database having a geo-spatial software in order to plot pixilated points correlated to the insurance portfolio data.

10. The system of claim 7 wherein the processor includes a geo-spatial application for scripting the insurance portfolio data.

11. The system of claim 7 wherein the gradient features comprise various graphical indicia depicted on a map and each indicia representative of different data points.

12. A method of conducting data analysis comprising the steps of:
modeling incremental tail loss at pixilated points; and
developing a grid of the pixilated points representative of specific events across a wide geographic area correlated to a risk managed layer (RML).

13. The method of claim 12 further comprising the step of:
selecting events in the RML from an exceedance probability curve modeled from insurance portfolio data.

14. The method of claim 12 further comprising the step of:
developing a map to identify preferential places for insurance growth or loss prevention.

15. The method of claim 12 further comprising the step of:
developing a map including a zip code index that compares the attractiveness of writing business in one zip code versus another zip code.

16. The method of claim 12 wherein the RML includes the same-value and same-construction exposures located in the nodes or pixilated points of an equally-spaced grid.

17. The method of claim 12 further comprising the step of modeling grid level tail losses for an existing insurance portfolio in order to evaluate the sensitivity of each geographic area to the increase in losses in the RML.

18. The method of claim 12 further comprising the step of calculating the tail loss for each location in the grid.

19. The method of claim 18 further comprising the step of determining tail loss contribution in order to provide a spatial pattern that will be unique to each particular insurer based on the individual insurer's portfolio, which drives the losses in the RML.

20. The method of claim 19 further comprising the step of approximating the changes to losses in RML that occur by addition of incremental exposure to the losses of the incremental portfolio.

21. The method of claim 19 further comprising the step of modeling incremental exposure by uniformly distributing pixilated points geographically, so that all areas of interest are accessed in terms of their relative impact on the losses to the RML.

22. The method of claim 19 further comprising the step of obtaining results for the grid losses at each location level and using the RML events for each insurer's analysis to calculate a contribution to the insurer's RML losses.

23. The method of claim 19 further comprising the step of overlaying maps having expected loss and concentration of policy data and generating an overall map depicting gradient features that are representative of catastrophe losses by using different graphical indicia.

24. The method of claim 19 wherein the tail loss is equal to the RML.

25. The method of claim 12 further comprising the step of selecting events from an exceedance probability curve where the RML is unbounded with respect to the return period.

26. The method of claim 12 further comprising the step of selecting events from an exceedance probability curve where each loss on the EP curve is paired with a simulation event.

27. A system for displaying geographic and insurance portfolio data comprising:
an end user device, including a computer readable signal-bearing medium, such medium having a circuit for receiving insurance portfolio data and data parameters input by a user of the end user device and the data parameters for calculating a spatial distribution of events that contribute to tail loss with respect to the insurance portfolio data; and
map data received by the end user device, the map data depicting the spatial distribution using gradient features.

28. The system of claim 27 wherein the end user device is a computer connected to a network and transmitting and receiving insurance portfolio data via the internet and displaying the map data, including pixilated points representative of specific events for a RML to provide an estimate of incremental tail loss for each pixilated point.

29. The system of claim 27 wherein the end user device is connected to the internet and is capable of receiving email and the email including data representative of events for a RML for providing an estimate of incremental tail loss with respect to particular geographic region.
